(19) United States
(12) Patent Application Publication
(10) Pub. No.: US 2015/0351605 A1
(43) Pub. Date: Dec. 10, 2015

(54) SYSTEM FOR SUPPLYING AND TREATING WATER FOR A WASHING MACHINE, IN PARTICULAR A DISHWASHER

(71) Applicant: BITRON S.P.A., Torino (IT)

(72) Inventor: Enzo BRIGNONE, Frazione Monastero Dronero (Cuneo) (IT)

(73) Assignee: BITRON S.p.A, Torino (IT)

(21) Appl. No.: 14/759,463

(22) PCT Filed: Apr. 23, 2014
(86) PCT No.: PCT/IB2014/060929

§ 371 Date: Jul. 7, 2015

(30) Foreign Application Priority Data
Apr. 24, 2013 (IT) TO2013A000338

(51) Int. Cl. A47L 15/42; C02F 5/08

(52) U.S. Cl. CPC A47L 15/4229; C02F 5/083; C02F 2303/22; C02F 2209/40; C02F 2101/10

(57) ABSTRACT

A dishwasher system having an electronic control unit (ECU). The control unit is designed to control selectively, in predetermined ways, as a function of the hardness of the water, and through the electric valves: the quantity of water used for forming the brine used for each operation of regenerating the softening substances contained in the first tank; and the frequency of the operations of regenerating and washing the softening substances.

The present invention relates in general to the field of washing machines, and in particular to dishwashers.

More specifically, the present invention relates to a system for supplying and treating water for such a machine, of the type defined in the preamble of claim 1.

A system for supplying and treating water of the type specified above is known from European Patent Application EP 2 561 790 A1, in the name of the present applicant.

EP 0 741 991 A1 describes a regeneration device including electronic control means designed to vary the volume of the water used for regeneration as a function of the water hardness, the number of washing cycles executed and the total volume of water treated in a given time interval. The volume of water used for each regeneration is determined by controlling the opening time of an electric water supply valve.

Further water treatment systems for dishwashers are described in DE 100 27 844 A1 and EP 1 114 607 A1.

In a dishwasher, as is known, in order to reduce the hardness of the water available at the place of use, the water used for washing the dishes is brought into contact with substances having water-softening properties, such as ion-exchange resins. These substances or resins must be periodically regenerated by a flow of brine formed by passing a certain quantity of water through the salt tank. This quantity can be controlled in various ways, for example by providing a suitable collecting container having an appropriate predetermined volume, or by measuring it with a flow meter, or by opening an electric valve for a predetermined time interval.

In washing machines, and particularly in dishwashers, it is becoming increasingly important to reduce water consumption.

This mainly implies a reduction of the quantity of water used for washing.

However, it is also possible to make an appreciable contribution in this respect by reducing the quantities of water used for the regeneration of the water-softening resins and for the washing of these resins after each regeneration operation.

Indeed, the regeneration of the softening resins generally requires quantities of water of the order of 100-200 cc, and the subsequent washing of these resins may require quantities of water of the order of 1500 cc.

One object of the present invention is therefore to propose a system for supplying and treating water which can contribute to the achievement of this aim, by enabling the consumption of water and electricity to be reduced appreciably.

A further object of the present invention is to propose a system for supplying and treating water which enables costs to be reduced appreciably by reducing the quantity of water-softening substances used and the quantity of salt required on each occasion for their regeneration.

This and other objects are achieved according to the invention with a system for supplying and treating water of the type defined above, having the characteristics defined in the attached claim 1.

Conveniently, in this system the electronic control means may be designed to cause, through the aforesaid electric valve means, the performance of the operations of regeneration and washing of the softening substances with a frequency at least equal to two washing cycles of the machine, when the water hardness indicated by said indicator means lies within a first predetermined range of relatively low values, for example from 10 to 20 German degrees (° d).

Furthermore, said electronic control means may be designed to cause, through the aforesaid electric valve means, the performance of an operation of regeneration and washing of the softening substances in each washing cycle of the machine, with quantities of water for the formation of the brine and for the washing of the softening substances increasing in predetermined ways with an increase in the water hardness indicated by the aforesaid indicator means, when the indicated hardness lies within a second predetermined range of values which are relatively high and greater than the values of said first range.

This second range of values of water hardness may extend, for example, from about 20 German degrees upwards.

According to a further characteristic, in a system for supplying and treating water according to the present invention intended for use in a dishwasher capable of washing 12 table settings, the aforesaid first tank has an internal volume capable of containing a volume of not more than 400 cc of ion-exchange softening substances, having an exchange capacity of about 1.9 eq/l.

Typically, this first tank has an at least approximately cylindrical shape. If this tank has a cross section with an average area S (expressed in cm², for example) and a height h (expressed in cm), the ratio S/h is conveniently between about 20 and about 55.

Further characteristics and advantages of the present invention will be apparent from the following detailed description, provided purely by way of non-limiting example, with reference to the attached drawings, in which:

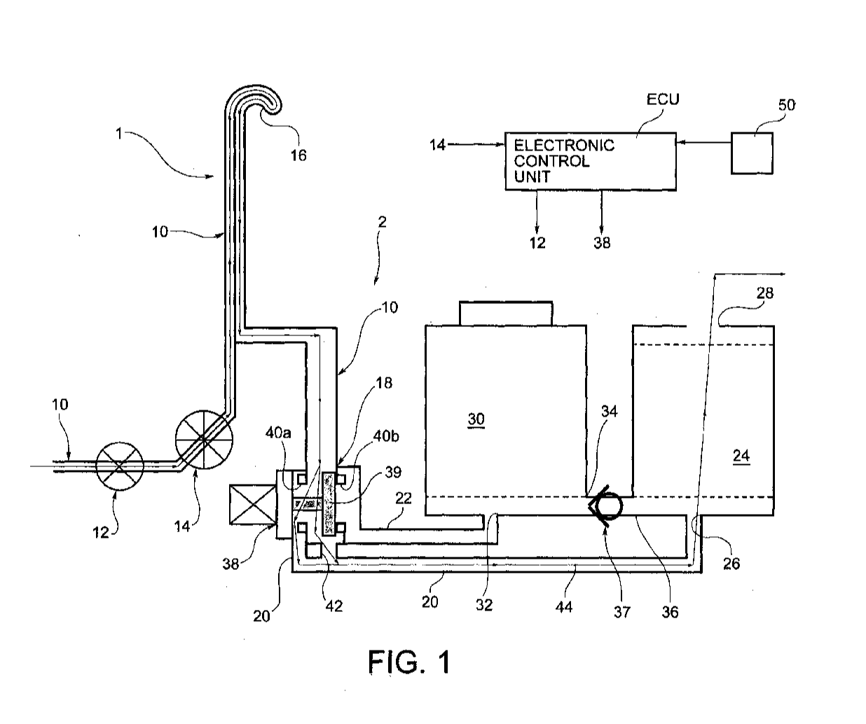

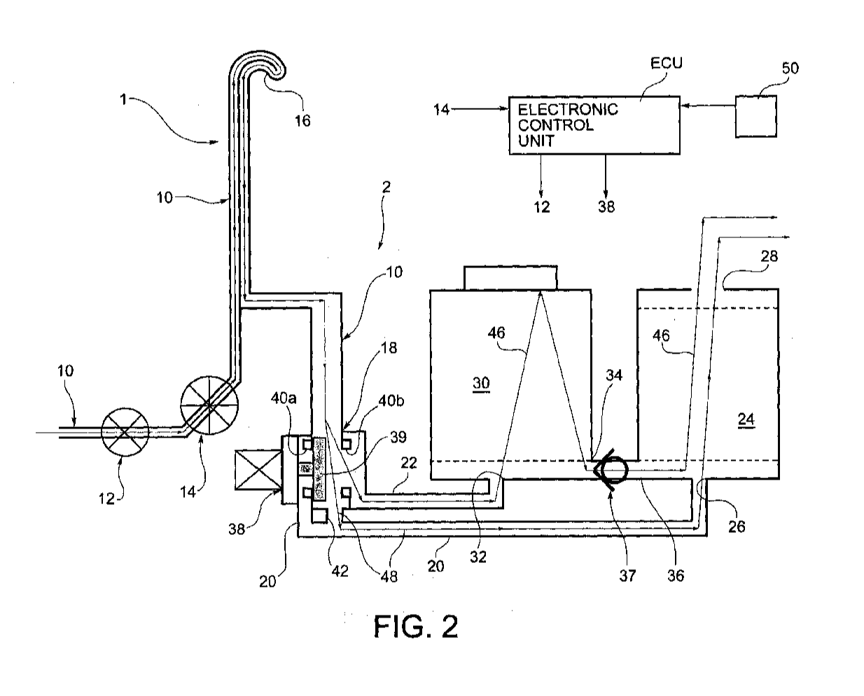

FIG. 1 is a schematic representation of a system according to the present invention, shown in a step of the softening treatment of the water used for washing the dishes, and FIG. 2 is a schematic representation of the system of FIG. 1, shown in a step of regeneration of the softening substances.

In the drawings, the number 1 indicates the whole of a system for supplying and treating water according to the present invention, in particular for a dishwasher of a known type (not illustrated).

This system 1 comprises a water-softening device which is indicated as a whole by 2, and which will now be described in detail.

In the embodiment illustrated by way of example in the drawings, the water-softening device 2 has a supply line 10, having an upstream portion in which an electric filling valve 12 and a flow gauge 14 are fitted.

After this portion, the supply line 10 has an air gap portion 16.

Downstream of the latter, the line 10 has a branch-off point 18 at which it forms a first and a second branch indicated by 20 and 22 respectively.

The water-softening device 2 further comprises a first tank 24 for containing substances with softening properties, in particular ion-exchange resins. This tank 24 has an inlet opening 26 for a flow of water to be softened and an outlet opening 28 for the flow of softened water.

The number 30 indicates a second tank for containing salt. This tank 30 has a water inlet opening 32 and an outlet opening 34 for a regenerating brine formed following the dissolution of salt in the water.

A line 36, in which a one-way valve 37 is positioned, connects the second tank to the first tank 24, to enable the brine formed in the second tank 30 to flow out towards the first tank 24.

The first branch 20 of the supply line 10 is connected to the inlet opening 26 of the first tank 24, while the second branch 22 is connected to the inlet opening 32 of the second tank 30.

In the embodiment illustrated by way of example, a switching valve 38, particularly an electric valve, is located at the branch-off point 18 of the supply line 10.

The valve 38 has a shutter 39 adapted to cause the water to flow into the first branch 20 or the second branch 22, by closing the free aperture of a first or a second valve seat 40a, 40b which forms the inlet of the corresponding branch 20, 22.

The valve 38 further comprises a supplementary passage 42, which puts the supply line 10 constantly into communication with the first branch 20, independently of the position of the shutter 39.

During the step of the softening treatment of the supplied water (FIG. 1), the shutter 39 of the valve 38 assumes a first operating position in which it blocks the outflow from the supply line 10 towards the second branch 22, by closing the aperture of the seat 40b, while it allows the flow into the first branch 20 towards the first tank 24 through the aperture of the seat 40a.

Thus all of the water flowing in the line 10 is directed, through the aperture of the seat 40a or the passage 42, directly into the first branch 20 and then into the first tank 24, where it is softened, as indicated by the path indicated by 44 in FIG. 1.

During the step of regeneration of the softening substances (FIG. 2), the shutter 39 of the valve 38 assumes a second operating position in which it allows the flow of water from the supply line 10 towards the second branch 22, by closing the aperture of the seat 40a and leaving open the aperture of the seat 40b.

Thus the water supplied to the second branch 22 is directed into the second tank 30, where it forms a brine which, when it subsequently passes through the first tank 24, regenerates the softening substances (see the path indicated by 46 in FIG. 2).

In the embodiment illustrated in the drawings, even during the regeneration step in which the shutter 39 closes the aperture of the inlet seat 40a of the first branch 20, part of the flow of supplied water continues to be directed through the passage 42 into the first branch 20 and thence into the first tank 24 (see the path indicated by 48 in FIG. 2). This prevents the passage of the whole supply flow through the salt tank 30, which would be functionally unnecessary and could also cause dangerous blockages.

It should also be noted that the ratio between the flows of water in the first and second branches 20, 22 depends on the apertures of the passage 42 and of the seats 40a, 40b, that is to say on fixed geometrical values, which can be specified with very high precision and low tolerances, thus providing highly precise operation.

In the embodiment described above, the quantities of water used for washing the dishes, forming the regenerating brine and washing the softening substances after the regenerating operations are determined by means of the flow gauge 14. However, it is possible to provide variant embodiments in which, for example, the volume of water used for forming the regenerating brine is determined differently, for example by means of a suitable collecting container having a predetermined volume, or by opening an electric water flow control valve for predetermined time intervals.

The system for supplying and treating water 1 further comprises an indicator device 50 of a known type, adapted to supply signals or data indicative of the hardness of the water used.

The system 1 further comprises an electronic control unit ECU connected to the indicator device 50 and to the flow gauge 14, as well as to the electric valves 12 and 38.

The electronic control unit ECU may be made as a unit specifically dedicated to the system for supplying and treating water 1, or its functions may be implemented using an electronic control unit of the machine with which the system for supplying and treating water 1 is associated.

This control unit ECU is designed to control selectively, in predetermined ways, as a function of the hardness of the water used, indicated by the device 50, and through the electric valves 12 and 38:
the quantity of water used for forming the brine used for each operation of regenerating the softening substances contained in the tank 24;
the quantity of water used for washing the softening substances contained in the tank 24, after each regeneration operation; and
the frequency of the operations of regenerating and washing these water-softening substances.

By providing coordinated control of two or more of these parameters, the system for supplying and treating water according to the invention makes it possible to achieve the objects mentioned in the introduction to the present description.

In particular, the electronic control unit ECU may conveniently be designed to cause, through the valves 12 and 38, the performance of operations of regeneration and washing of the softening substances contained in the tank 24, with a frequency at least equal to two washing cycles in the machine, when the water hardness indicated by the device 50 lies within a first predetermined range of relatively low values, for example between about 10 and about 20 German degrees.

The electronic control unit ECU may also be conveniently designed to cause, through the electric valves 12 and 38, the performance of an operation of regeneration and washing of the softening substances in each washing cycle of the machine, with quantities of water for the formation of the brine and for the washing of the softening substances increasing in predetermined ways with an increase in the water hardness indicated by the indicator 50, when the indicated hardness lies within a second predetermined range of values which are relatively high and greater than the values of the aforesaid first range. This second range of values of water hardness conveniently extends, for example, from about 20 German degrees upwards.

The volume of softening resins used is crucial for the optimization of operating efficiency and the consequent reduction of water and salt consumption for the operations of regenerating the softening substances, and for the reduction of energy consumption and costs.

According to a further aspect of the invention, for a dishwasher capable of washing 12 table settings, the first tank 24, that is to say the tank for the softening substances, has an internal volume capable of containing a volume of not more than 400 cc of ion-exchange softening substances, having an exchange capacity of about 1.9 eq/l.

The tank 24 generally has an at least approximately cylindrical shape. If, as mentioned above, this tank has a cross section having an average area S and a height h expressed in consistent units of measurement (for example, cm² and cm respectively), the ratio S/h is conveniently between about 20 and about 55.

A ratio S/h between these extremes provides high operating efficiency and a reasonable compromise between the requirements of reducing the overall dimensions and reducing the quantity of softening resins used.

Clearly, provided that the principle of the invention is retained, the forms of application and the details of embodiment can be varied widely from what has been described and illustrated purely by way of non-limiting example, without thereby departing from the scope of protection of the invention as defined by the attached claims.

1. System for supplying and treating water for a washing machine, in particular a dishwasher, comprising:
a first tank (24) for containing substances with water-softening properties, having at least one inlet opening (26) for water to be softened and an outlet opening (28) for softened water,
a second salt-containing tank (30), having at least one water inlet opening (32) and an outlet opening (34) for a regenerating brine formed following the dissolution of the salt in the water,
a line (36) connecting the second tank (30) to the first tank (34) for the outflow of the brine formed in the second tank (30) towards the first tank (24),
a water supply line (10) having a branch-off point (18) into a first branch (20) supplying the first tank (24) and into a second branch (22) which leads to the inlet opening (32) of the second tank (30),
first electric valve means (12) adapted to control the flow of water through said supply line (10),
second electric valve means (38) adapted to control a flow of water towards and through the second tank (30) for forming the regenerating brine,
means (14) for determining the amounts of water used for washing the dishes, forming the regenerating brine and washing the softening substances after a regenerating operation; and
electronic control means (ECU) connected to said determining means (14) and to said first and second electric valve means (12, 38);
the system being characterized in that it further comprises indicator means (50) adapted to provide signals or data indicative of the hardness of the water used, and in that the control means (ECU) are designed to control, and if necessary selectively vary, in predetermined ways, as a function of the water hardness indicated by the indicator means (50), and through said first and second electric valve means (12, 38):
the quantity of water used for forming the brine used for each operation of regenerating the softening substances contained in said first tank (24), and
the frequency of the operations of regenerating and washing said softening substances.

2. System according to claim 1, wherein said electronic control means (ECU) are also designed to control and, if necessary, selectively vary, as a function of the water hardness indicated by the indicator means (50) and through said electric valve means (12, 38), the amount of water used for washing said softening substances after a regeneration operation.

3. System according to claim 1, wherein said electronic control means (ECU) are designed to cause, through said electric valve means (12, 38), the performance of the operations of regeneration and washing of the softening substances with a frequency at least equal to two washing cycles of the machine, when the water hardness indicated by said indicator means (50) is comprised in a first predetermined range of relatively low values.

4. A system according to claim 3, wherein said electronic control means (ECU) are designed to cause, through said electric valve means (12, 38), the performance of an operation of regeneration and washing of the softening substances at each washing cycle of the machine, with quantities of water for forming the brine and for washing the softening substances which increase in predetermined ways with an increase in water hardness indicated by the aforesaid indicator means (50), when the indicated water hardness lies within a second predetermined range of values which are relatively high and greater than the values of said first range.

5. System according to claim 3, wherein said first range of values of water hardness extends from about 10 to about 20 German degrees.

6. System according to claim 4, wherein said second range of values of water hardness extends from about 20 German degrees upwards.

7. System according to claim 1, for a dishwasher capable of washing 12 table settings, wherein said first tank (24) contains a volume of less than 400 cc of ion-exchange softening substances having an exchange capacity of about 1.9 eq/l.

8. System according to claim 1, wherein said first tank (24) has an at least approximately cylindrical shape, with a cross section having an average area S, in mm², and a height h, in mm, such that the S/h ratio is between about 20 and about 55.
